(19) United States
(12) Patent Application Publication
(10) Pub. No.: US 2007/0229512 A1
(43) Pub. Date: Oct. 4, 2007

(54) Device and program for image formation and processing

(75) Inventor: Yasushi Tsukamoto, Osaka (JP)

Correspondence Address: Kyocera Technology Development;Intellectual Property Administration, Suite 400, 1855 Gateway Blvd., Concord, CA, 94520, US

(73) Assignee: Kyocera Mita Corporation, Osaka-shi (JP)

(21) Appl. No.: 11/496,346

(22) Filed: Jul. 31, 2006

(30) Foreign Application Priority Data
Mar. 29, 2006 (JP) JP2006-090071

(51) Int. Cl. G06T 11/00

(52) U.S. Cl. 345/467; 358/1.11

(57) ABSTRACT

A method for efficient incorporation of additional language fonts in creating panel display data, print image data, and facsimile transmission image data. The method enables MFPs to easily create an image data containing a new font when character font data and symbol codes are added or altered. Input units are for inputting image data. Image control unit is comprised of font control unit, font data read-and-write control unit, and font data memory unit. The font data memory unit stores character font data by associating it with the character. The font data read-and-write control unit controls reading and writing of the font data to the font data memory unit. The font control unit obtains font data used for image data through the font data read-and-write unit, and controls format-conversion and output of the font data depending on the display mode or image forming mode. The display unit displays the display data and the converted font. The output units are for outputting the image data containing converted fonts.

### FIELD OF THE INVENTION

This invention relates to an image forming device and an image processing program, and more particularly to an image forming device and a image processing program that are installed to optimally function on MFPs having multiple functions such as of a printer, a copier, and a facsimile.

### BACKGROUND OF THE INVENTION

In recent years, provided for MFPs (Multifunction Peripherals or Multi-Functional Peripherals) are devices that are functional in multiple languages including Japanese, English, Korean, Chinese, etc. Configurations of existing MFPs supporting multiple languages and their fonts is such that, unless a desired language font data is stored in each of print font data unit, transmission font data unit, and display font data memory unit, a print image data cannot be created, characters cannot be added to image data, and output cannot be made to the output panel. However, storing of multiple language font data in advance is considerably costly, and required languages differ from user to user. The present invention was made in order to address the above issues, and enables efficient image forming device and an image processing program to easily create an image data containing a new font when character font data and symbol codes are added or altered. The present invention enables efficient incorporation of additional language fonts in creating panel display data, print image data, and facsimile transmission image data.

### SUMMARY OF THE INVENTION

Methods, computer program products, computing and printing systems for enabling efficient image forming device and an image processing program to easily create an image data containing a new font when character font data and symbol codes are added or altered are described. The present invention enables efficient incorporation of additional language fonts in creating panel display data, print image data, and facsimile transmission image data.

In recent years, provided for MFPs are devices that are functional in multiple languages other than Japanese, such as English, Korean, and Chinese.

FIG. 3 shows a configuration comprising, in relation to input printer (image) data, at the printer control unit 1, creating print image data with font data from the print font data memory unit 3 and outputting to the image control unit 5; outputting image data read from the scanner processing unit 7 to the image control unit 5; based on an instruction from the display panel 11 through the panel control unit 9, at the image control unit 5, controlling output of such print image data or read image data to the printer processing unit 13 and enabling print out; controlling output to the transmission control unit 15; with transmission font data from transmission font data memory unit 17, adding a transmitter or a title or ID of a transmitter to a header or footer at the transmission image control unit 19; transmitting to the external networks (not shown) via facsimile; and displaying various display data from the image control unit 5, through the panel control unit 9, on the display panel 11.

FIG. 3 shows a display font data memory unit 21 that stores display font data to be displayed on the display panel 11, whose read-and-write operations are controlled by the panel control unit 9, and a reception process unit 23 that outputs a facsimile signal received, for example, from a network to the image control unit 5.

For making this type of MFP functional in multiple languages, unless a desired language font data is stored in each of the print font data unit 3, the transmission font data unit 17, and the display font data memory unit 21, a print image data cannot be created, characters cannot be added to image data, and output cannot be made to the output panel 11. However, storing of multiple language font data in advance is considerably costly, and required languages differ from user to user.

Accordingly, a prior art MFP stores one to two main language fonts on the display font data memory unit 21 as standard language (for example, Japanese and alphanumeric characters) in addition to the language used in the country a device is installed, and is configured to enable switching displaying among multiple languages mainly from the display panel 11, and minimizes inconvenience in panel operation.

Methods for supporting multiple languages are disclosed in Japanese Published Patent Applications No. 07-115496 and No. 09-107453.

However, a problem with the aforementioned MFPs is that adding optional language font data to the display font memory unit 21 enables display of an additional language to the display unit 11, but since it does not exist on the print font data memory unit 3 and the transmission font data memory unit 17, even if instruction is given from the display unit 11, print image data cannot be created, or additional font data cannot be added to transmission image data, and addition of font data is limited to a standard language.

For instance, a company name and the like are often inserted in facsimile transmission image data as a transmitter source. When a language other than a standard language is added, although the display panel 11 can display it, such additional language can not be displayed on a facsimile transmission image, resulting in the problem that it can not be read by the receiver of a facsimile transmission image.

Furthermore, because an additional font cannot be added to transmission image data, input has sometimes been controlled such that additional font data cannot be stored in anywhere other than the display font data memory unit 21.

In recent years, since the aforementioned MFP has been increasingly used in many countries and connected through networks, solutions to the aforementioned issues to make it functional in multiple languages are strongly desired.

The present invention was made in order to address such issues, by providing an image forming device and an image forming program to easily create the image data containing a font when font data of characters and symbol codes are added and altered.

Image forming device of the present invention for solving such issues comprises of the following: an input unit for inputting image data to be formed; a font data memory unit for storing font data corresponding to a character code in a read-and-write manner by associating it with the font data; a font data read-and-write control unit for controlling reading and writing of the font data, in relation to the font data memory unit; a font control unit for acquiring the font data corresponding to the character code used for the image data through the font data read-and-write unit and controlling conversion of the acquired font data, depending on the display mode or image forming mode; a display unit for displaying the converted font data on a panel; and an output unit for outputting the image data containing a font, to which the converted font data has been added, to the external units.

In a further embodiment of the present invention, the font data read-and-write control unit can be configured to manage and control storing of multiple types of language fonts.

In a further embodiment of the present invention, the aforementioned output unit can be configured to output the image data containing a converted font to the external units through a network.

In a yet further embodiment of the present invention, the output unit can be configured to print the image data containing a converted font.

Additionally, an image forming program of the present invention executes the following on an image forming control computer that controls conversion of font data, depending on a display mode or an image forming mode: input processing for inputting image data to be formed; read-and-write processing for reading and writing of font data corresponding to a character code by associating with the character code, in relation to the font data memory unit; font conversion control processing for acquiring the font data corresponding to the character code used for image data from font data memory unit and for controlling conversion of the acquired font data, depending on a display mode or an image processing mode; display processing for displaying the converted font data on a panel; and output processing for outputting the image data containing a font, to which the converted font data has been added, to the external units.

### DESCRIPTION OF THE DRAWINGS

FIG. 1 is a block diagram illustrating a preferred embodiment of an image forming device of the present invention.

FIG. 2 is a block diagram illustrating a configuration example of an image control unit of FIG. 1 of the present invention.

FIG. 3 is a block diagram illustrating an example of an image forming device.

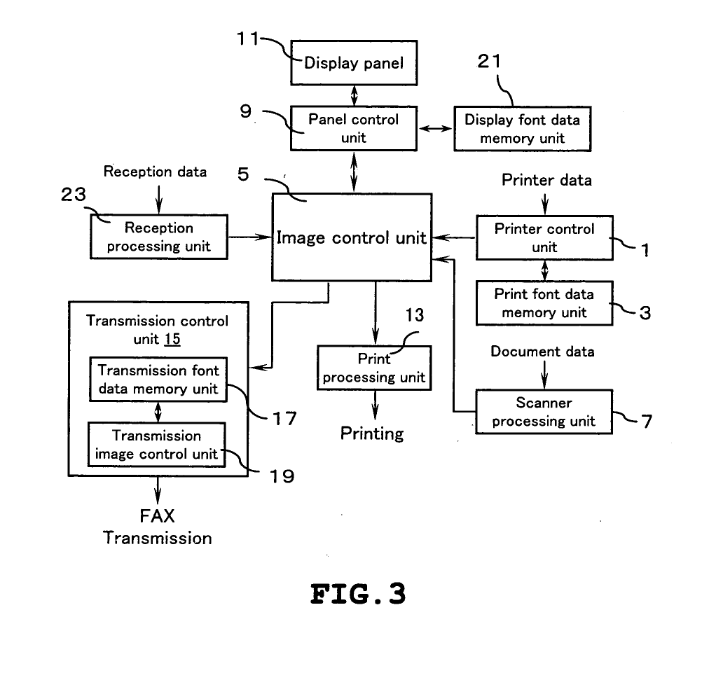

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

An image forming device and image forming program of the present invention is configured to: input image data at an input unit; store font data corresponding to a character code to a font data memory unit in a read-and-write manner by associating with the character code; in relation to the font data memory unit, control reading of the font data at a font data read-and-write unit; obtain the font data corresponding to a character code used for the image data, through the font data read-and-write unit, at a font control unit; control conversion of the acquired font data, depending on a display mode or an image forming mode; display the converted font data on a panel; and output the image data containing a font, to which the converted font data has been added, to the external units. This configuration enables easy creation of the image data containing a font even when font data associating with characters and symbol codes are added.

Also, in a configuration such that the aforementioned font data read-and-write control unit manages and controls storing of multiple types of language font data, even when language font data is added and altered, the font data containing various fonts can be easily created with the added and altered language font data.

Additionally, in a configuration wherein the aforementioned output unit outputs to the external units through a network, also as for image data that is to be output to the external units through a network, the added and altered image data containing a font can be transmitted.

Furthermore, in a configuration wherein the aforementioned output unit prints image data, the added and altered image data containing a font can be printed.

The following describes the preferred embodiments of the present invention with reference to the figures.

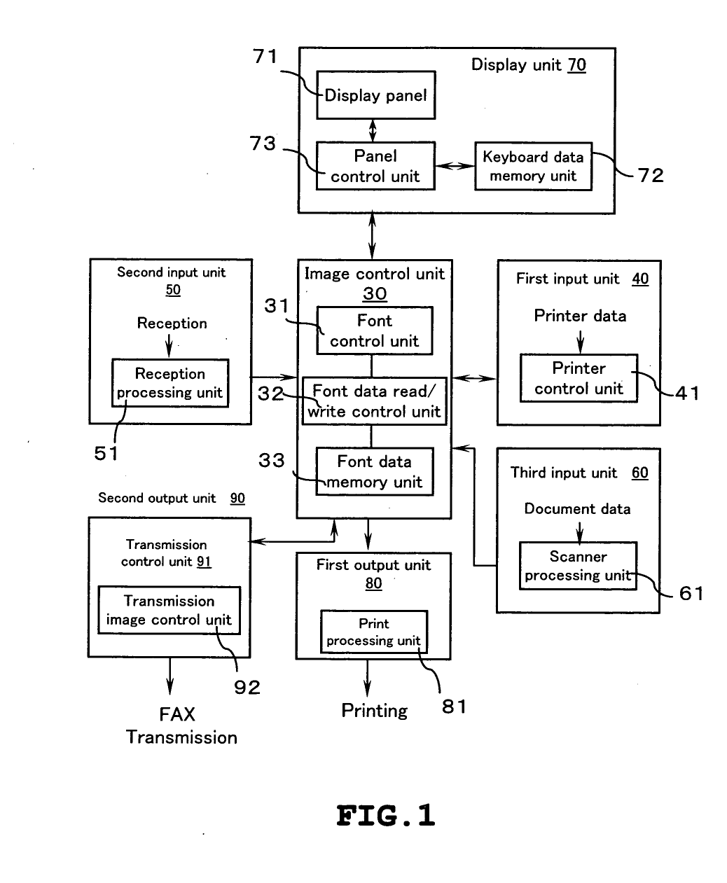

FIG. 1 is a block diagram indicating a preferred embodiment of an image forming device of the present invention.

In FIG. 1, an image forming device of the present invention schematically comprises of the image control unit 30 as the hub, the first input unit 40, the second input unit 50, the third input unit 60, the first input unit 80, and the second input unit 90.

The image control unit 30 comprises of the font control unit 31, the font data read-and-write control unit 32, and the font data memory unit 33. The detailed functions are described hereinafter.

The first input unit 40 comprises of the printer unit control unit 41, and has functions of inputting printer (image) data from a computer (not shown) to the printer control unit 41; at the printer control unit 41, creating print image data with font data acquired through the font control unit 31, which is described hereinafter; and outputting it to the image control unit 30.

The second input unit 50 comprises of the reception control unit 51, and has functions of deciphering and converting data received through a network (not shown), for instance, facsimile reception number, to image data, and outputting it to the image control unit 30. Additionally, it has other functions, for instance, of inputting additional language data, which is described hereinafter.

Meanwhile, language data comprises of identification data indicating country code, character string data which is character codes to be displayed arranged in a table format, font (character) data associated with the character code and others for displaying on the display panel 71 and for printing and transmission, software keyboard layout data corresponding to a language. This specification simply describes character codes, font data, and keyboard layout data.

The third input unit 60 comprises of conventional scanner processing unit 61. It has functions of reading and converting document data into digital image data, and outputting to the image control unit 30.

The display unit 70 comprises of conventional display panel 71 which has panel display function and touch input function, the keyboard data memory unit 72 which stores multiple keyboard layout data by language, which is displayed on the display panel 71, and the panel control unit 73 which creates a display keyboard image, based on the keyboard layout data, and controls its display on display panel 71. On the keyboard data memory unit 72, keyboard layout data of a standard language such as Japanese and key font data used for the key location have been stored in advance.

The panel control unit 73 has a function of outputting instruction information, which is an input instruction from the display panel 71, to the image control unit 30, by touch input by an operator.

The first output unit 80 is a conventional printer engine and so forth that prints out and outputs print image data on a paper from the first input unit 40, second input unit 50, and third input unit 60, which is output from image control unit 30.

The second output unit 90 is the transmittal control unit 91 which converts image data containing a font into a certain transmittal signal, and also, for instance, transmits it via facsimile to the external networks (drawings omitted) through a certain protocol. It also comprises of the transmission image control unit 92 that adds transmission font data output from the font control unit 31 as a header and/or a footer of transmission image data as a transmitter or a title or ID of a transmitter.

Meanwhile, based on an input instruction from the display panel 71, font data is configured to be added to image data.

The image control unit 30 has, at the aforementioned font control unit 31, the font data read-and-write control unit 32, and the font data memory unit 33, functions of storing language font data in a read-and-write manner, and controlling in reading it; creating display data to display operation conditions and various selection instruction contents, outputting to the panel control unit 73; based on an instruction from the display panel 71, outputting image data from the printer control unit 41, the scanner processing unit 61, or the reception processing unit 51 to the printer processing unit 81 as print image data, and to transmission control unit 91 as transmission image data; and functions described hereinafter.

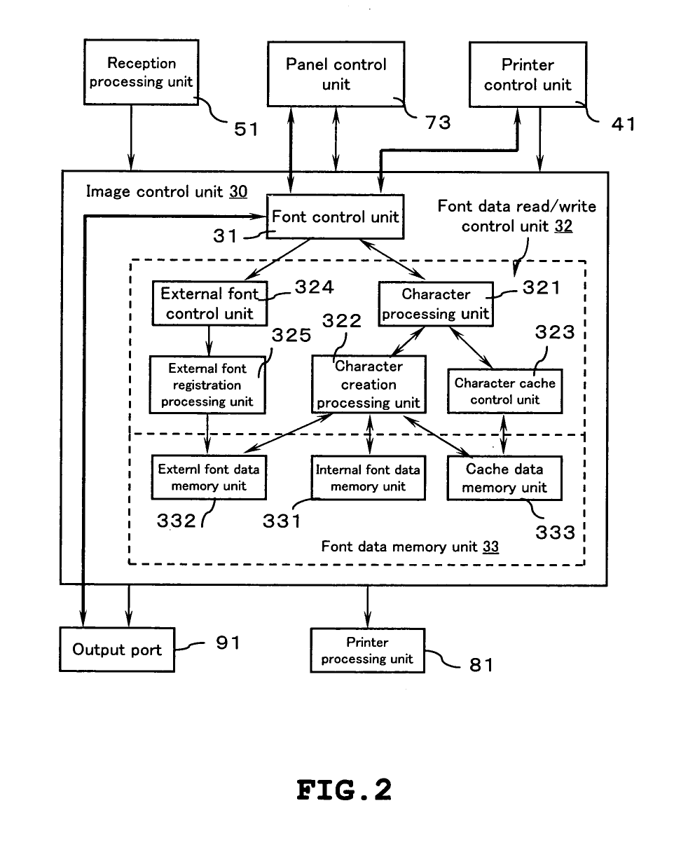

The font data read-and-write control unit 32 and the font data memory unit 33 comprise of configurations described in FIG. 2.

The font data read-and-write control unit 32 comprises of the character processing unit 321 connected to the font control unit 31, the character creating processing unit 322 and the character cache control unit 323 which are connected to the character processing unit 321. It also comprises of the external font unit 324 connected to the font control unit 31 and the external unit font registration processing unit 325 connected to the external font unit 324, and, in relation to font data memory unit 33, has a function of controlling read-and-write operations upon the font data.

The font data memory unit 33 comprises of the internal font data memory unit 331, the external font data memory unit 332, and the cache data memory unit 333, which are connected to the character creation processing unit 322. The external font data memory unit 332 is connected to the external font registration processing unit 325, and the cache data memory unit 333 is connected to character cache control unit 323. They store font data corresponding to characters and symbol codes in a read-and-write manner by associating it with the characters, etc.

The internal font data memory unit 331 stores Japanese and others as standard language font data in advance. The font data read-and-write control unit 32 manages and controls storing of multiple types of language font data for each language.

Upon receiving external font data from the font control unit 31, the external font control unit 324 stores and controls at the external font data memory unit 33, through the external font registration processing unit 325, by corresponding it to the character code.

Accordingly, based on an instruction from the display panel 71, in adding language font data, the font control unit 31 is configured to store an additional language code and the corresponding additional font data, through the external font control unit 324 and the external font registration unit 325, on the external font data memory unit 332.

Additionally, in acquiring internal font data corresponding to a character code, based on an instruction from the font control unit 31, character processing unit 321 reads font data corresponding to a character code from the internal font data memory unit 331, through the character creation processing unit 322, and outputs it to the font control unit 31. Meanwhile, the character processing unit 321 stores the font data that has been already read on the font cache data memory unit 333, through the character cache control unit 323. It also reads font data corresponding to a character code, through the character cache control unit 31, and outputs it to the font cache control unit 31.

In acquiring font data corresponding to an additional character code, based on an instruction from the font control unit 31, the character processing unit 321 reads font data corresponding to a character code, through the character creation processing unit 322, from the cache data memory unit 333, through the external font data memory unit 332 or the character cache control unit 323.

Based on an instruction from the display panel 71, in storing keyboard layout data corresponding to additional language data and key font data, the font control unit 31 controls storing on the keyboard data memory unit 72 through the panel control unit 72.

The font control unit 31 has functions of converting the format of the acquired font data, depending on a display mode for displaying on the display panel 11, and controlling its output to the panel control unit 73; converting the format depending on an image forming mode of print image data, and controlling its output to the printer control unit 41; and converting the format depending on an additional mode for a header and a footer in transmission image data as an address book or other document data, and controlling its output to the transmission image control unit 91.

In other words, the font control unit 31 has a function of controlling conversion of the acquired font data, depending on a display mode and a mode used for image data such as print image data and transmission image data.

The following briefly describes operation of the aforementioned image forming device.

First, the registration operation of an additional font is described.

For instance, when an external memory media storing additional font data is connected to the reception processing unit 51 of the second input unit 50, based on an instruction from the display panel 71, the font control unit 31 controls storing of external font data, to the external font data memory unit 332, through the external font control unit 324 and the external font registration processing unit 325 by associating a character code.

The following describes, for instance, operation to display additional font data on the display panel 71.

Based on a language selection instruction at the display panel 71, the panel control unit 73 reads keyboard layout data and others at one's request from the keyboard data memory unit 72. Meanwhile, the font control unit 31 obtains font data corresponding to a character code through the character processing unit 321 and the character creation processing unit 322 from the external font data memory unit 332 or the cache data memory unit 333 through the character cache control unit 323, converts a format for a display mode, and outputs it to the panel control unit 73.

The panel control unit 73 combines display keyboard data and additional font data and controls display on the display panel 71.

More particularly, the following describes an operation of forming image data from printer data using additional font data.

The font control unit 31, based on an instruction (character code) from the printer control unit 41, obtains corresponding font data from the external font data memory unit 332 or the cache data memory unit 333 through the character cache control unit 323, through the character processing unit 321 and the character creation processing unit 322, converts a format of the font data, depending on a formation mode of print image data, and outputs the converted font data to the printer control unit 41.

The printer control unit 41 forms print image data using converted font data and outputs it to the image control unit 30.

An image forming device of the present invention configured in this manner comprises of: the first input unit 40, the second input unit 50, and the third input unit 60 which input image data to be formed; the font data memory unit 33 storing font data corresponding to a character in a read-and-write manner associated with the character; the font data read-and-write control unit 32 controlling the font data in a read-and-write manner to the font data memory unit 33; and the font control unit 31 obtaining font data corresponding to a character used for the image data through the font data read-and-write unit 32 and controls conversions of the obtained font data, depending on a display mode or an image forming mode at the display unit 70. The further configuration includes displaying the converted font data on the display panel 71 in the display unit 70 and externally outputting image data containing a font of the converted font data from the first out put unit 80 and the second output unit 90.

Accordingly, character font data can be easily added or modified, and moreover, even when character font data is added or modified, users can easily create display data, print image data, and transmission image data with the font data.

Because the font data read-and-write control unit 32 manages and controls storing of multiple types of language font data by each language, various language font data can be easily added or modified, and more conveniently, print image data and transmission image can be easily created with the modified language font data, which promotes use in a variety of countries.

It is another advantage that image data containing a converted font can be printed at the output unit 80 and the image data containing a converted font can be externally output from the second output unit 90 through a network.

Embodiments of the image forming processing device of the present invention can enable application not only to character font data, but also to other font data such as of characters and symbol codes.

An image forming processing program of the present invention is for causing a computer to perform, with respect to a an image forming control device including the font control unit 31, the font data read-and-write control unit 32, and the font data memory unit 33 as main units: input processing for inputting image data to be formed; read-and-write processing for read-and-write operations of font data corresponding to a character code associated with the character code to the font data memory unit 33; font conversion control processing for obtaining the font data corresponding to the character code used for the image data from the font data memory unit 33 and performing conversions of the obtained font data, depending on a display mode or an image forming mode; display processing for displaying converted fonts on a panel; and output processing for externally outputting image data containing the converted fonts.

Although this invention has been largely described using terminology pertaining to printer drivers, one skilled in this art could see how the disclosed methods can be used with other device drivers. The foregoing descriptions used printer drivers rather than general device drivers for concreteness of the explanations, but they also apply to other device drivers. Similarly, the foregoing descriptions of the preferred embodiments generally use examples pertaining to printer driver settings, but they are to be understood as similarly applicable to other kinds of device drivers.

Although the terminology and description of this invention may seem to have assumed a certain platform, one skilled in this art could see how the disclosed methods can be used with other operating systems, such as Windows, DOS, Unix, Linux, Palm OS, or Apple OS, and in a variety of devices, including personal computers, network appliance, handheld computer, personal digital assistant, handheld and multimedia devices, etc. One skilled in this art could also see how the user could be provided with more choices, or how the invention could be automated to make one or more of the steps in the methods of the invention invisible to the end user.

While this invention has been described in conjunction with its specific embodiments, it is evident that many alternatives, modifications and variations will be apparent to those skilled in the art. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. An image processing device comprising:
an input unit for inputting an image data to be formed;
a font data memory unit that stores in a read-and-write manner font data corresponding to a character code, wherein the stored font data comprises its association with the character code;
a font data read-and-write control unit that controls read-and-write operations on the font data to the font data memory unit;
a font control unit that obtains font data corresponding to the character code used for the image data through the font data read-and-write control unit, and controls conversion of the font data depending on a display mode and/or an image formation mode;
a display unit that panel-displays the converted font data; and
an output unit that externally outputs an image data comprising font data comprising the converted font data.

2. The image processing device of claim 1, wherein the font data read-and-write control unit manages and storage-controls a plurality of language font data sets.

3. The image processing device of claim 1, wherein the externally outputting of the image data comprising the converted font data comprises the output unit externally outputting the image data comprising the converted font data through a network.

4. The image processing device of claim 2, wherein the externally outputting of the image data comprising the converted font data comprises the output unit externally outputting the image data comprising the converted font data through a network.

5. The image processing device of claim 1, wherein the externally outputting of the image data comprising the converted font data comprises the output unit printing the image data comprising the converted font data.

6. The image processing device of claim 2, wherein the externally outputting of the image data comprising the converted font data comprises the output unit printing the image data comprising the converted font data.

7. The image processing device of claim 1, wherein the font data read-and-write control unit manages and storage-controls a plurality of language font data sets; wherein the externally outputting of the image data comprising the converted font data comprises the output unit externally outputting the image data comprising the converted font data through a network; and wherein the externally outputting of the image data comprising the converted font data comprises the output unit printing the image data comprising the converted font data.

8. A program for causing a computer, with respect to an image forming and control device that controls conversion of font data depending on a display mode and/or an image formation mode, to perform the method steps of:
input processing for inputting image data to be formed;
read-and-write processing for performing a read-and-write storing operation to a font data memory unit of font data corresponding to a character code, wherein the stored font data comprises its association with the character code;
font conversion control processing for obtaining font data corresponding to the character code used for the image data from the font data memory unit, and controlling conversion of the font data depending on a display mode and/or an image formation mode;
display processing for panel-displaying the converted font data; and
output processing for externally outputting the image data comprising font data comprising the converted font data.

9. The program of claim 8, wherein the font data memory unit manages and storage-controls a plurality of language font data sets.

10. The program of claim 8, wherein the externally outputting of the image data comprising the converted font data comprises the output unit externally outputting the image data comprising the converted font data through a network.

11. The program of claim 8, wherein the externally outputting of the image data comprising the converted font data comprises the output unit printing the image data comprising the converted font data.

12. The program of claim 8, wherein the font data read-and-write control unit manages and storage-controls a plurality of language font data sets; wherein the externally outputting of the image data comprising the converted font data comprises the output unit externally outputting the image data comprising the converted font data through a network; and wherein the externally outputting of the image data comprising the converted font data comprises the output unit printing the image data comprising the converted font data.

13. A method for processing an image, comprising:
input processing for inputting image data to be formed;
read-and-write processing for performing a read-and-write storing operation to a font data memory unit of font data corresponding to a character code, wherein the stored font data comprises its association with the character code;
font conversion control processing for obtaining font data corresponding to the character code used for the image data from the font data memory unit, and controlling conversion of the font data depending on a display mode and/or an image formation mode;
display processing for panel-displaying the converted font data; and
output processing for externally outputting the image data comprising font data comprising the converted font data.

14. The method of claim 13, wherein the font data memory unit manages and storage-controls a plurality of language font data sets.

15. The method of claim 13, wherein the externally outputting of the image data comprising the converted font data comprises the output unit externally outputting the image data comprising the converted font data through a network.

16. The method of claim 13, wherein the externally outputting of the image data comprising the converted font data comprises the output unit printing the image data comprising the converted font data.

17. The method of claim 13, wherein the font data read-and-write control unit manages and storage-controls a plurality of language font data sets; wherein the externally outputting of the image data comprising the converted font data comprises the output unit externally outputting the image data comprising the converted font data through a network; and wherein the externally outputting of the image data comprising the converted font data comprises the output unit printing the image data comprising the converted font data.
